(19) United States
(12) Patent Application Publication
(10) Pub. No.: US 2009/0048360 A1
(43) Pub. Date: Feb. 19, 2009

(54) Cork Substitute

(76) Inventor: Gregg E. Thorne, Shoreview, MN (US)

Correspondence Address: KRAMM LAW, P.O. BOX 20726, BLOOMINGTON, MN, 55420-0726, US

(21) Appl. No.: 11/838,063

(22) Filed: Aug. 13, 2007

(51) Int. Cl. C08J 9/00; B29C 65/00

(52) U.S. Cl. 521/143; 264/41

(57) ABSTRACT

A process and article for use as a substitute for natural cork. The article has a cork substitute material comprising an expanded polyolefin foam having a density of about between 6.6 lb/ft³ and 12.5 lb/ft³ and a compressive strength of about between 126 Psi and 406 Psi (0.86 MPa and 2.8 MPa) at 25% Strain.

### BACKGROUND OF THE INVENTION

This invention relates generally to cork substitutes, and more particularly, to cork substitute materials, articles and methods of manufacture.

A problem addressed by this invention is finding a suitable substitute in a product comprising natural cork. The majority of world supply of natural cork is limited to a single supply source, Portugal. Natural cork material is harvested from the bark of a Cork Oak tree, Quercus suber, for commercial use. Demand has been rising in the face of relatively inelastic supply. Securing cork deliveries sometimes require advance orders up to 6 months. A reason for the situation lies in natural cork production.

The forestry and harvesting of cork bark from a Cork Oak tree is limited to those mature enough to be harvested being at least 25 years old, and can only be harvested once every nine years. Those Cork Oak trees eligible for harvesting require delicate stripping of the outer bark by skilled workers using specialized cork axes in only the spring or summer season. Some cork oak trees have been harvested prematurely resulting in inconsistent quality. The harvested bark is seasoned in stacks for about six months to reach a desired level of moisture and sorted prior to processing.

The additional cork processing step involves boiling cork planks in water to remove organic solids lodged in the lenticels or pores of the bark and to make the cork more pliable and then again stacking the planks to reach a desired moisture level. Afterwards, the cork planks are graded by thickness, porosity and appearance. The cleanest, or pit free cork, is expensive and costs are rising. Additional cork production steps which cost even more in time and manual labor include slicing cork planks into strips, manually punching the cork, sorting cork into quality categories, polishing, washing in hydrogen peroxide (H₂O₂) to eliminate microorganisms that might contribute to cork taint, again oven or air drying to bring the moisture level in the cork to about 6% to 8% and then several finishing steps to bring the cork to customer specifications. What is needed is a suitable product cork substitute having a lower cost, greater supply and more efficient means of production.

Over time, the organic cork material itself as currently used in products can suffer some disadvantages. Cork can be adversely affected by a variety of different environmental conditions. Natural cork absorbs from the atmosphere and retains moisture that makes cork susceptible to rot, mold, and mildew. Cork has a limited life span and when cork is outside exposed to sun and humidity, the cork can eventually break down into powder. What is needed is a cork substitute material that does not suffer from these shortcomings.

So there has been a long-felt need for a solution to the foregoing problem and a failure of others to solve it. A marketplace example of attempts to substitute a synthetic material onto a product that traditionally used cork is the fishing rod. A natural cork handle of a fishing rod has sometimes been replaced with a synthetic ethylene vinyl acetate (EVA) foam handle. While the soft spongy EVA foam can recover from indentations created under torque or pressure in a rod holder, it still fails to emulate some important characteristics of cork. For example, despite being in the market for many years, the soft spongy EVA foam still suffers during a fish encounter from dampening a rod blank vibration within the synthetic handle which may produce unsatisfactory results from a decreased sensitivity to within the angler's hand. Consequently, natural cork remains a valued superior material for the essential purpose of catching fish.

Through years of inventor study, research and experimentation, synthetic materials were searched and evaluated for a material with suitable malleability to simulate desired natural cork characteristics. Eventually, the inventor has discovered that an expanded polypropylene (EPP) plastic foam material can be processed into a new form that satisfies key categories of needed cork substitute characteristics. However, additional problems arose in some of the early trials of EPP plastic foam material where it did not lathe or shape well. For example, while being shaped on a lathe, EPP plastic foam material could melt from heat generated by friction from sandpapering the EPP plastic foam material to shape it. Also, some of the expanded beads of the EPP plastic foam would frequently rip off the outer surface during lathing or shaping which produced unacceptably large pits and tears. To resolve these problems, the inventor conducted additional intensive study which led to the conception of the present invention. Experimenting further with smaller micro beads produced a denser, more compact construction that created a new EPP plastic foam material which more closely resembled desired physical characteristics of natural cork.

These and other objectives and advantages of the invention will appear more fully from the following description.

### SHORT STATEMENT OF THE INVENTION

Accordingly, the present invention has been created in view of those problems and disadvantages, and so an object of the present invention is to provide a cork substitute material.

A further object of the present invention is to provide a cork substitute article, such as a handle for a fishing rod, which comprises a synthetic cork material capable of improving handle features and productivity and reducing the production cost of the handle, and thereby providing fishing rods having moderate prices.

Another object of the present invention is to provide a cork substitute article, such as a fishing rod handle, which directly transmits a vibration from a fish striking a baited hook to the hand of a user holding the rod handle for an enjoyable fishing experience.

In order to accomplish the above objects, the primary embodiment of the present invention provides an article having a cork substitute material comprising an expanded polyolefin foam The expanded polyolefin foam has a density of between 6.6 lb/ft3 and 12.5 lb/ft3. The expanded polyolefin foam also has a compressive strength of between 126 Psi and 406 Psi (0.86 MPa and 2.8 MPa) at 25% Strain.

### DETAILED DESCRIPTION OF THE INVENTION

Accordingly, the cork substitute article and process of the present invention includes an article having a cork substitute material comprising an expanded polyolefin foam. The expanded polyolefin foam typically has a density of between about 6.6 lb/ft3 and 12.5 lb/ft3; more preferably, from about 8.6 lb/ft3 to about 10.5 lb/ft3. Also, the expanded polyolefin foam typically has a compressive strength of about between 126 Psi and 406 Psi (0.86 MPa and 2.8 MPa) at 25% Strain; more preferably, from about 300 Psi to about 406 Psi (0.86 MPa and 2.8 MPa) at 25% Strain.

The process of using and the article of the cork substitute invention is not limited to, but may be selected from the group comprising a portion of a fishing rod handle, fishing rod handle, fishing pole handle, fixed support line handling means, an instrument, a tool, wine bottle stopper, bulletin board, coaster, hot pad, acoustic insulation, sealing for lids, flooring, gaskets for engines, floor tiles insulation in walls, floor and ceiling of a cold storage room, refrigerator truck and other articles that replace natural cork with the cork substitute material.

The expanded polyolefin foam may have, but is not limited to, a feature selected from the group comprising an insert, grain, laminated, internal hinge, fitted, multiple density, color, and fused surface.

The molding of the article of the cork substitute invention occurs in an expansion molding process. An advantage of this invention is that it is not limited to a particular type of expansion molding process. Consequently, the details of an expansion molding process is not disclosed herein because a variety of them are available commercially and are well known to those of ordinary skill in the art. As an example, one such expansion molding process for producing an article having a core of expanded foam shaped suitable for use in a preferred embodiment of the present invention is disclosed in U.S. Patent Application 20040256879 which is incorporated by reference thereto.

The molding of the article of the cork substitute invention may also occur in an injection molding process. A similar advantage of this invention is that it is not limited to any particular type of injection molding process to practice this invention. So, the details of an injection molding process is not disclosed here due to the number of such processes being commercially available and being well known to those of ordinary skill in the art. As an example, one such injection molding process for producing a shaped laminate in one step suitable for use in a preferred embodiment of the present invention is disclosed in U.S. Pat. No. 7,150,615 which is incorporated by reference thereto.

A compression molding process would also work for molding the article of the cork substitute invention. No particular type of compression molding process to practice this invention is required. The details of a compression molding process is not disclosed here because of the number of such processes being commercially available and being well known to those of average skill in the pertinent field.

A process for producing a plastic article having a cork substitute material is provided in accordance with the present cork substitute invention. The process for producing a plastic article having a cork substitute material comprises the step of molding a plurality of plastic beads into a plastic foam. The expanded polyolefin foam product typically has a density of between about 6.6 lb/ft3 and 12.5 lb/ft3; more preferably, from about 8.6 lb/ft3 to about 10.5 lb/ft3. Also, the expanded polyolefin foam typically has a compressive strength of about between 126 Psi and 406 Psi (0.86 MPa and 2.8 MPa) at 25% Strain; more preferably, from about 300 Psi to about 406 Psi (0.86 MPa and 2.8 MPa) at 25% Strain. Preferred embodiments of the invention include but are not limited to an expansion, an injection, or a compression molding process to practice this invention. Even combinations, such as of expansion and compression molding processes may be suitable. So, the details of these molding processes are not disclosed herein due to the number of such processes being commercially available and being well known to those of ordinary skill in the art. An example of a commercial supplier and manufacturer of expandable polyolefin beads and foam products, applications, additives, assembly, composites, and materials is JSP International Co., 1443 E. 12 Mile Rd., Madison Heights Mich. 48071 United States. An example of an expansion molding process suitable for use in a preferred embodiment of the present invention is disclosed in U.S. Patent Application 20010009683 which is incorporated by reference thereto. In this process of producing, the step of molding occurs with supplying polyolefin foamed beads having a bulk density of about between 5 lb/ft3 and 11 lb/ft3; transporting the foamed beads through a passageway defined by at least one structural member; and subjecting the foamed beads to a heating region.

In another expansion molding process of a shaped article, the process further comprises the steps of: a) providing a first mold half matable to a second mold half which open and close with respect to one another to define a mold cavity; b) providing an inlet mounted on the mold apparatus for introducing a foamable material into the mold cavity; c) filling the mold cavity through the inlet with the foamable material, the foamable material comprising a polyolefin bead foam, the polyolefin bead foam having a bulk density of about between 5 lb/ft3 and 11 lb/ft3; and d) opening the second mold half with respect to the first mold half to withdraw the finished shaped article. Further details of this molding process are not disclosed herein due to the number of such processes being commercially available and being well known to those of ordinary skill in the art. As an example, one such expansion molding process using a steam-chest for producing a shaped laminate in one step suitable for use in a preferred embodiment of the present invention is disclosed in U.S. Patent Application 20040150127 which is incorporated by reference thereto.

The present invention provides an improved use as a cork substitute material which can easily be used in a range of products covering diverse applications such as a portion of a fishing rod handle, fishing rod handle, fishing pole handle, fixed support line handling means, an instrument, a tool, wine bottle stopper, bulletin board, coaster, hot pad, acoustic insulation, sealing for lids, flooring, gaskets for engines, floor tiles insulation in walls, floor and ceiling of a cold storage room, refrigerator truck and other articles that replace natural cork with the cork substitute material. Still other uses of the invention include the manufacture of musical instruments, particularly woodwind instruments, where it is used to fasten together different segments of the instrument and to make the seams airtight. Sheets of cork substitute material, for example, may be used to make floor tiles and bulletin boards or as insulation in walls, floor and ceiling of a cold storage room or refrigerator truck. So, many of the invention uses are for applications involving cork replacement products.

The process of using the article having a cork substitute material of the present invention teaches the use of an expanded polyolefin foam that has a feature selected from the group comprising an insert, grain, laminated, internal hinge, fitted, multiple density, color, and fused surface. An example of using such an article having a cork substitute material is a fishing rod having a fishing rod handle made of an expanded polyolefin foam such as an expanded polypropylene (EPP) foam having a density of about between 6.6 lb/ft3 and 12.5 lb/ft3. The fishing rod handle can be made from a plurality of portions of a fishing rod handle, such as rings or made from a single, continuous expanded polyolefin foam. The fishing rod handle can be made with an insert of a fishing reel housing base for reducing production time and costs. The fishing rod handle can be made with a grain for texture and antislippage. The fishing rod handle can be made into a special laminate or with an internal hinge. The fishing rod handle can now be custom made and fitted in ways not previously possible within economic constraints. The fishing rod handle can be made to have multiple densities or a fused surface. Instead of the typical blonde color of natural cork, the fishing rod handle can now be customized to have another color such a black for resisting deterioration from ultraviolet radiation.

An advantage of the present invention cork substitute foam article may in numerous situations be used as a direct substitute for cork with the added benefit of being able to be manufactured to resemble cork structure, appearance and color. In addition, the plastic foam article of the present invention offers in particular applications the following advantages of ductile, oxidation resistance, low odor, antislippage, color stability, oil resistance, and toughness. The invention provides improved weatherability to withstand both hot and cold ambient temperature extremes and resistance to rot, molds, and mildew. Also, with the capability of the invention material for coloring with a dark color, the invention further resists deterioration from ultraviolet rays. Moreover, the invention helps the environment by relieving some world consumption pressure on cork tree natural resources with the provision of an alternative recyclable material.

In today's highly competitive and cost conscious environment, a significant economic advantage of the invention over natural cork is a lower cost per volume of product. Other benefits of the foaming invention over a cork solid are improved insulation from a lower thermal conductivity, reduced thermal expansion, improved resistance to wind load, improved acoustic damping properties, and a higher stiffness. Finally, the cork substitute of the present invention has the important advantage of providing a material that can be worked in some of the same ways as existing corkworking methods such as sawing, nailing, screwing, lathing, rasping and sandpapering.

This disclosure describes the invention and the manner and process of making and using it to enable any person skilled in the pertinent or most nearly connected technological area of the invention to make and use it. The specific physical embodiments herein disclosed merely exemplify the invention which may be embodied in other specific structures. While the preferred embodiment has been described, the details may be changed without departing from the invention as defined by the claims.

What is claimed is:

1. An article having a cork substitute material, comprising: an expanded polyolefin foam, the expanded polyolefin foam having a density of about between 6.6 lb/ft3 and 12.5 lb/ft3.

2. The article of claim 1, wherein the expanded polyolefin foam has a density of about between 8.6 lb/ft3 and 10.5 lb/ft3; and wherein the expanded polyolefin foam has a compressive strength of about between 300 Psi and 406 Psi (0.86 MPa and 2.8 MPa) at 25% Strain.

3. The article of claim 1, wherein the expanded polyolefin foam is an expanded polypropylene (EPP) foam; and wherein the article is selected from the group comprising a portion of a fishing rod handle, fishing rod handle, fishing pole handle, fixed support line handling means, an instrument, a tool, wine bottle stopper, bulletin board, coaster, hot pad, acoustic insulation, sealing for lids, flooring, gasket for engines, floor tiles, insulation in walls, floor and ceiling of a cold storage room, refrigerator truck and other articles that replace natural cork with the expanded polyolefin foam.

4. The article of claim 1, wherein the expanded polyolefin foam has a feature selected from the group comprising an insert, grain, laminated, internal hinge, fitted, multiple density, color, and fused surface.

5. The article of claim 1, wherein the molding occurs in an expansion molding process.

6. The article of claim 1, wherein the molding occurs in an injection molding process.

7. The article of claim 1, wherein the molding occurs in a compression molding process.

8. A process for producing a plastic article having a cork substitute material, comprising the step of molding a plurality of plastic beads into a plastic foam, the plastic foam having a density of about between 6.6 lb/ft3 and 12.5 lb/ft3, and the plastic foam having a compressive strength of about between 126 Psi and 406 Psi (0.86 MPa and 2.8 MPa) at 25% Strain.

9. The process of claim 8, wherein the step of molding occurs with supplying polyolefin foamed beads having a bulk density between 5 lb/ft3 and 11 lb/ft3; transporting the foamed beads through a passageway defined by at least one structural member; and subjecting the foamed beads to a heating region.

10. The process of claim 8, wherein the step of molding occurs in an expansion molding process of a shaped article, the process further comprising the steps of:
a) providing a first mold half matable to a second mold half which open and close with respect to one another to define a mold cavity;
b) providing an inlet mounted on the mold apparatus for introducing a foamable material into the mold cavity;
c) filling the mold cavity through the inlet with the foamable material, the foamable material comprising a polyolefin bead foam, the polyolefin bead foam having a bulk density between 5 lb/ft3 and 11 lb/ft3; and
d) opening the second mold half with respect to the first mold half to withdraw the finished shaped article.

11. A process of using an article having a cork substitute material, comprising an expanded polyolefin foam, the expanded polyolefin foam having a density of about between 6.6 lb/ft3 and 12.5 lb/ft3.

12. The process of using the article of claim 11, wherein the expanded polyolefin foam has a density of about between 8.6 lb/ft3 and 10.5 lb/ft3; and wherein the expanded polyolefin foam has a physical property compressive strength of about between 300 Psi and 406 Psi (0.86 MPa and 2.8 MPa) at 25% Strain.

13. The process of using the article of claim 11, wherein the expanded polyolefin foam is an expanded polypropylene (EPP) foam; and wherein the article is selected from the group comprising a portion of a fishing rod handle, fishing rod handle, fishing pole handle, fixed support line handling means, an instrument, a tool, wine bottle stopper, bulletin board, coaster, hot pad, acoustic insulation, sealing for lids, flooring, gasket for engines, floor tiles, insulation in walls, floor and ceiling of a cold storage room, refrigerator truck and other articles that replace natural cork with the expanded polyolefin foam.

14. The process of using the article of claim 11, wherein the expanded polyolefin foam has a feature selected from the group comprising an insert, grain, laminated, internal hinge, fitted, multiple density, color, and fused surface.

15. The process of using the article of claim 11, wherein the molding occurs in an expansion molding process.

16. The process of using the article of claim 11, wherein the molding occurs in an injection molding process.

17. The process of using the article of claim 11, wherein the molding occurs in a compression molding process.

18. A process of using a method for making a plastic article having a cork substitute material, comprising the step of molding a plurality of plastic beads into a plastic foam, the plastic foam having a density of about between 6.6 lb/ft3 and 12.5 lb/ft3, and the plastic foam having a compressive strength of about between 126 Psi and 406 Psi (0.86 MPa and 2.8 MPa) at 25% Strain.

19. The process of using the method for making a plastic article having a cork substitute material of claim 18, wherein the step of molding occurs with supplying polyolefin foamed beads having a bulk density between 5 lb/ft3 and 11 lb/ft3; transporting the foamed beads through a passageway defined by at least one structural member; and subjecting the foamed beads to a heating region.

20. The process of using the method for making a plastic article having a cork substitute material of claim 18, wherein the step of molding occurs in an expansion molding process of a shaped article, the process further comprising the steps of:
a) providing a first mold half matable to a second mold half which open and close with respect to one another to define a mold cavity;
b) providing an inlet mounted on the mold apparatus for introducing a foamable material into the mold cavity;
c) filling the mold cavity through the inlet with the foamable material, the foamable material comprising a polyolefin bead foam, the polyolefin bead foam having a bulk density between 5 lb/ft3 and 11 lb/ft3; and
d) opening the second mold half with respect to the first mold half to withdraw the finished shaped article.
